(19) United States
(12) Patent Application Publication
(10) Pub. No.: US 2013/0171603 A1
(43) Pub. Date: Jul. 4, 2013

(54) Method and System for Presenting Interactive, Three-Dimensional Learning Tools

(71) Applicant: Logical Choice Technologies, Inc., Lawrenceville, GA (US)

(72) Inventors: Jonathan Randall Self, Doraville, GA (US); Cynthia Bertucci Kaye, Dacula, GA (US); Craig M. Selby, Marietta, GA (US); James Simpson, Atlanta, GA (US)

(73) Assignee: Logical Choice Technologies, Inc., Lawrenceville, GA (US)

(21) Appl. No.: 13/727,346

(22) Filed: Dec. 26, 2012

Related U.S. Application Data
(60) Provisional application No. 61/582,112, filed on Dec. 30, 2011.

(51) Int. Cl. G09B 5/06

(52) U.S. Cl. CPC G09B 5/065
USPC 434/317

(57) ABSTRACT

A system includes an education module (171) that is operable with, includes, or is operable to control three-dimensional figure generation software (170). The education module (171) is configured to present a three-dimensional interactive rendering (981) on a display (132) above an image (250) of an interactive book (150) disposed beneath a camera (130) that is operable with the education module (171). The three-dimensional interactive rendering (981) can be a game, an interaction scenario, or other image, and can be presented when a user (400) covers a user actuation target (304). A cut video (850) can be presented after the user actuation target (304) is covered but before the three-dimensional interactive rendering (981) is presented to provide a stimulating educational experience to a student.

### CROSS REFERENCE TO PRIOR APPLICATIONS

This application claims priority and benefit under 35 U.S.C. §119(e) from U.S. Provisional Application No. 61/582,112, filed Dec. 30, 2011.

### BACKGROUND

1. Technical Field

This invention relates generally to interactive learning tools, and more particularly to a three-dimensional interactive learning system and corresponding method therefor.

2. Background Art

Margaret McNamara coined the phrase “reading is fundamental.” On a more basic level, it is learning that is fundamental. Children and adults alike must continue to learn to grow, thrive, and prosper.

Traditionally learning occurred when a teacher presented information to students on a blackboard in a classroom. The teacher would explain the information while the students took notes. The students might ask questions. This is how information was transferred from teacher to student. In short, this was traditionally how students learned.

While this method worked well in practice, it has its limitations. First, the process requires students to gather in a formal environment and appointed times to learn. Second, some students may find the process of ingesting information from a blackboard to be boring or tedious. Third, students that are too young for the classroom may not be able to participate in such a traditional process.

There is thus a need for a learning tool and corresponding method that overcomes the aforementioned issues.

### BRIEF DESCRIPTION OF THE DRAWINGS

FIG. 1 illustrates one embodiment of a system configured in accordance with embodiments of the invention.

FIG. 2 illustrates one embodiment of an interactive book suitable for use with a three-dimensional interactive learning tool system configured in accordance with embodiments of the invention.

FIG. 3 illustrates one output result of an interactive book being used with a three-dimensional interactive learning tool system in accordance with embodiments of the invention.

FIGS. 4-18 illustrate features and use cases for systems configured in accordance with one or more embodiments of the invention, the use cases illustrating steps of a method.

FIG. 19 illustrates one output result of an interactive book being used with a three-dimensional interactive learning tool system in accordance with embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

Before describing in detail embodiments that are in accordance with the present invention, it should be observed that the embodiments reside primarily in combinations of method steps and apparatus components related to a three-dimensional interactive learning tool system. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

It will be appreciated that embodiments of the invention described herein may be comprised of one or more conventional processors and unique stored program instructions that control the one or more processors to implement, in conjunction with certain non-processor circuits, some, most, or all of the functions of providing output from a three-dimensional interactive learning tool system as described herein. The non-processor circuits may include, but are not limited to, a camera, a computer, USB devices, audio outputs, signal drivers, clock circuits, power source circuits, and user input devices. As such, these functions may be interpreted as steps of a method to perform the delivery of output from a three-dimensional interactive learning tool system. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Embodiments of the invention are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions. Also, reference designators shown herein in parenthesis indicate components shown in a figure other than the one in discussion. For example, talking about a device (10) while discussing figure A would refer to an element, 10, shown in figure other than figure A.

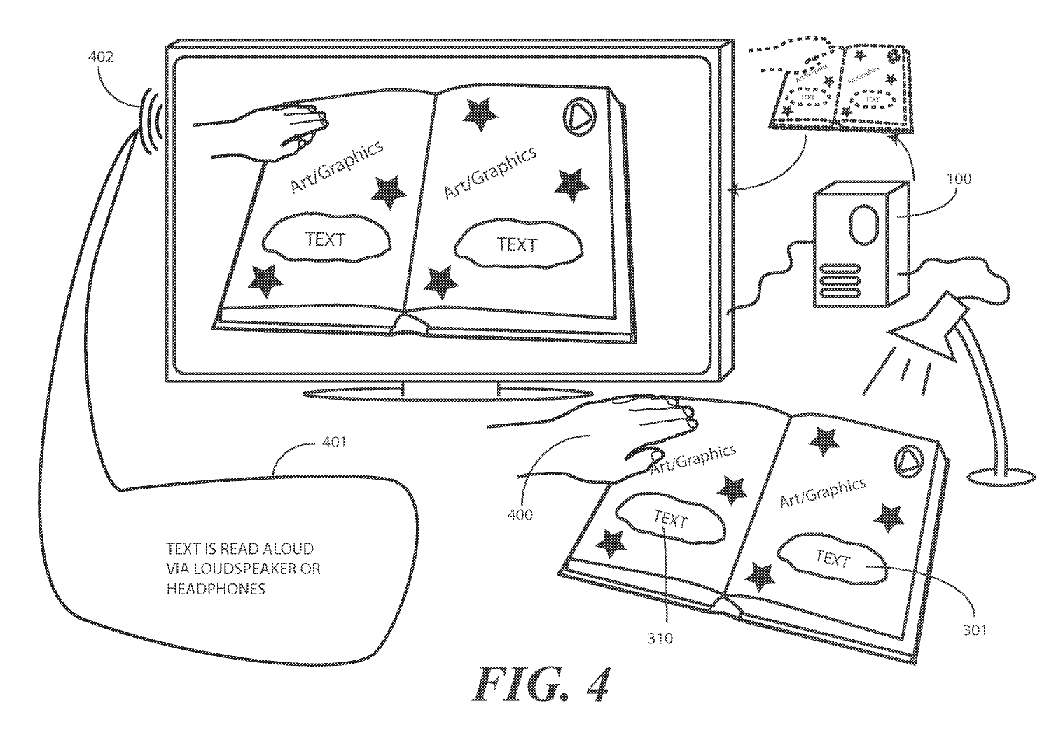

Embodiments of the present invention provide a learning tool that employs three-dimensional imagery on a computer screen that is triggered when a pre-defined interactive book is presented before a camera. The interactive book includes one or more user actuation targets that allow a user to interact with computer renderings corresponding to indicia on each of the pages. Illustrating by example, the user can cover a user actuation target to cause the computer to read the text printed on the currently open page. Additionally, the user can cover another user actuation target to cause a three-dimensional rendering that corresponds to text and/or graphics present on the currently open page to appear on a computer screen. Once the three-dimensional rendering appears, the user can cover other user actuation targets to interact with elements of the three-dimensional rendering, thereby making the elements move or respond to gesture input. A combination of prompts to the user, user gestures, and resulting animation of the elements in the three-dimensional rendering can be used to educate the user in the fields of reading, mathematics, science, or other fields. This interaction will be shown in greater detail in the use cases described with reference to FIGS. 4-18 below.

Embodiments of the present invention provide interactive educational tools that combine multiple educational modalities, e.g., visual, gesture, and auditory to form an engaging, exciting, and interactive world for today's student. Embodiments of the invention can comprise interactive books configured to allow a student to interact with a corresponding educational three-dimensional image to be presented on a computer screen. Additionally, the use of cut videos and interactive games teach learning concepts such as following directions, problem solving, directional sensing, and in one illustrative embodiment, starting an air boat.

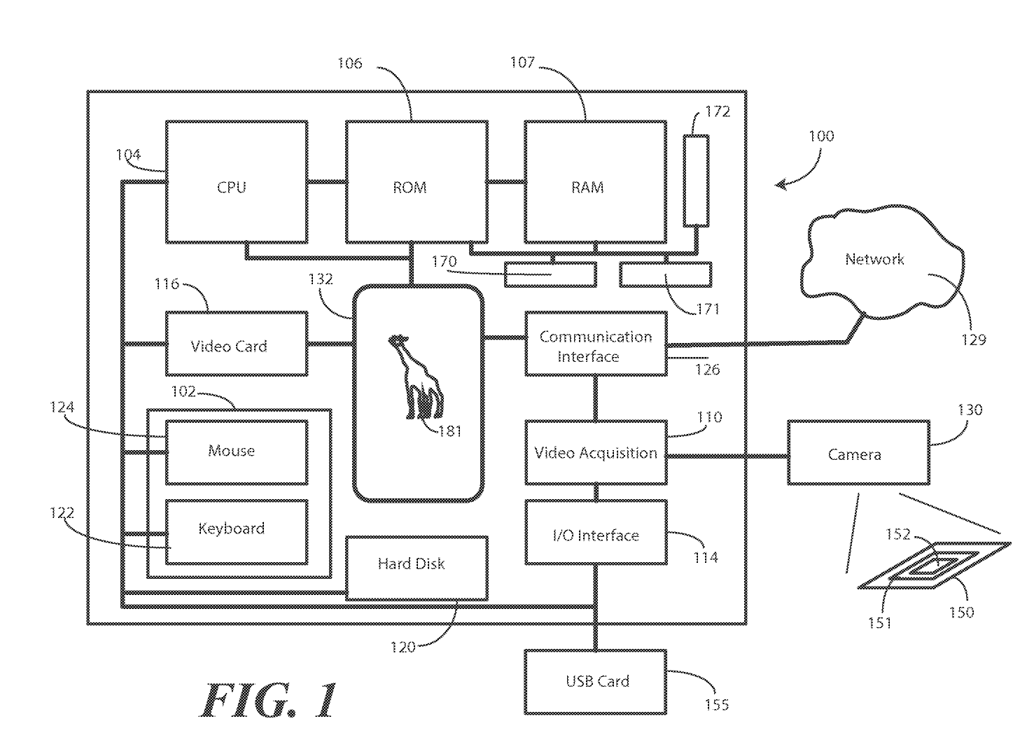

Turning now to FIG. 1, illustrated therein is one embodiment of a system configured in accordance with embodiments of the invention. The system includes illustrative equipment suitable for carrying out the methods and for constructing the apparatuses described herein. It should be understood that the illustrative system is used as one explanatory embodiment for simplicity of discussion. Those of ordinary skill in the art having the benefit of this disclosure will readily identify other, different systems with similar functionality that could be substituted for the illustrative equipment described herein.

In one embodiment of the system, a device 100 is provided. Examples of the device 100 include a personal computer, microcomputer, a workstation, a gaming device, or portable computer.

In one embodiment, a communication bus, shown illustratively with black lines in FIG. 1, permits communication and interaction between the various components of the device 100. The communication bus enables components to communicate instructions to any other component of the device 100 either directly or via another component. For example, a controller 104, which can be a microprocessor, combination of processors, or other type of computational processor, retrieves executable instructions stored in one or more of a read-only memory 106 or random-access memory 108.

The controller 104 uses the executable instructions to control and direct execution of the various components. For example, when the device 100 is turned ON, the controller 104 may retrieve one or more programs stored in a nonvolatile memory to initialize and activate the other components of the system. The executable instructions can be configured as software or firmware and can be written as executable code. In one embodiment, the read-only memory 106 may contain the operating system for the controller 104 or select programs used in the operation of the device 100. The random-access memory 108 can contain registers that are configured to store information, parameters, and variables that are created and modified during the execution of the operating system and programs.

The device 100 can optionally also include other elements as will be described below, including a hard disk to store programs and/or data that has been processed or is to be processed, a keyboard and/or mouse or other pointing device that allows a user to interact with the device 100 and programs, a touch-sensitive screen or a remote control, one or more communication interfaces adapted to transmit and receive data with one or more devices or networks, and memory card readers adapted to write or read data.

A video card 110 is coupled to a camera 130. The camera 130, in one embodiment, is can be any type of computer-operable camera having a suitable frame capture rate and resolution. For instance, in one embodiment the camera 130 can be a web camera or document camera. In one embodiment, the frame capture rate should be at least twenty frames per second. Cameras having a frame capture rate of between 20 and 60 frames per second are well for use with embodiments of the invention, although other frame rates can be used as well.

The camera 130 is configured to take consecutive images and to deliver image data to an input of the device 100. This image data is then delivered to the video card for processing and storage in memory. In one embodiment, the image data comprises one or more images of pages of the interactive book 150, cards, or other similar objects that are placed before the lens of the camera 130.

An education module 171, working with a three-dimensional figure generation or rendering program 170, is configured to detect a character, object, or image disposed on one or more pages of the interactive book 150 from the images of the camera 130 or image data corresponding thereto. The education module 171 then controls the various functions of the system, including an audio output program 172 and/or a three-dimensional figure generation program 170 to present educational output to the user. In one embodiment, the educational output comprises and augmentation of the image data by inserting a two-dimensional representation of an educational three-dimensional object and/or interactive scene into the image data to create augmented image data.

In one embodiment, the audio output program 172 is configured to deliver audio output corresponding to text or graphics on currently open pages of the interactive book 150 in response to a user covering a predefined user actuation target on the currently opened pages. In another embodiment, the three-dimensional figure generation program 170 can be configured to generate the two-dimensional representation of the educational three-dimensional object in response to the education module 171 detecting that a user has covered another user actuation target present on the currently opened pages. In yet another embodiment, the three-dimensional figure generation program 170 can be configured to retrieve predefined three-dimensional objects from the read-only memory 106 or the hard disk 120 in response to instructions from the education module 171.

In one embodiment, the educational three-dimensional object is an interactive scene that corresponds to one or more detected characters, objects, text lines, or images disposed on the pages of the interactive book 150. For instance, an educational, three-dimensional, interactive scene can be related to text, graphics, or indicia on currently opened pages by a predetermined criterion. Where the detected character, object, or image can comprise one or more words, the education module 171 can be configured to detect the one or more words from the image data. When a user covers an actuation target present on the page configured to “make the computer read the text, the education module 171 can be configured to read the text to the user. Alternatively, the education module 171 can be configured to augment the image data by presenting a two-dimensional representation of the one or more words in a presentation region of augmented image data. Other techniques for triggering the presentation of three-dimensional educational images on a display 132 will be described herein.

A user interface 102, which can include a mouse 124, keyboard 122, or other device, allows a user to manipulate the device 100 and educational programs described herein. A communication interface 126 can provide various forms of output such as audio output. A communication network 128, such as the Internet, may be coupled to the device for the delivery of data. The executable code and data of each program enabling the education module 171 and the other interactive three-dimensional learning tools can be stored on any of the hard disk 120, the read-only memory 106, or the random-access memory 108.

In one embodiment, the education module 171, and optionally the three-dimensional figure generation program 170 and audio output program 172, can be stored in an external device, such as USB card 155, which is configured as a non-volatile memory. In such an embodiment, the controller 104 may retrieve the executable code comprising the education module 171, the audio output program 172, and three-dimensional figure generation program 170 through a card interface 114 when the read-only USB device 155 is coupled to the card interface 114. In one embodiment, the controller 104 controls and directs execution of the instructions or software code portions of the program or programs of the interactive three-dimensional learning tool.

In one embodiment, the education module 171 includes an integrated three-dimensional figure generation program 170 and an integrated audio output program 172. Alternatively, the education module 171 can operate, or be operable with, a separate three-dimensional figure generation program 170 and an audio output program 172 that is integral with the device 100. Three-dimensional figure generation programs 170, which are sometimes referred to as an “augmented reality programs,” are available from a variety of vendors. For example, the principle of real time insertion of a virtual object into an image coming from a camera or other video acquisition means using that software is described in patent application WO/2004/012445, entitled “Method and System Enabling Real Time Mixing of Synthetic Images and Video Images by a User.” In one embodiment, three-dimensional figure generation program 170, such as that manufactured by Total Immersion under the brand name D'Fusion®, is operable on the device 100.

In one embodiment of a computer-implemented method of teaching reading using the education module 171, a user places an open page of an interactive book 150 before the camera 130. The camera 130 is then able to capture visible objects 151, which can be graphics, text, user actuation targets, or other visible elements. These visible objects 151 can additionally be photographs, pictures, or other graphics. The visible objects 151 can also be configured as any number of objects, including colored background shapes, patterned objects, pictures, computer graphic images, and so forth.

In one embodiment, the various visible objects 151 are encoded with a special marker 152 that can be uniquely identified by the education module 171 and correlated with a predetermined educational function. For example, where the visible object 151 is a user actuation target, the education module 171 can detect the special marker 152 and correlate it with a “present interactive three-dimensional rendering” function, a “present gaming scenario” function, or a “read text” function. When a user covers the user actuation target with a hand or other object, the education module 171 can be configured to execute the corresponding function. The special marker 152 can comprise photographs, pictures, letters, words, symbols, characters, objects, silhouettes, or other visual markers. In one embodiment, the special marker 152 is embedded into the visible object 151.

The education module 171 receives one or more video images of the interactive book 150 as image data delivered from the camera 130. The camera 130 captures one or more video images of the interactive book 150 and delivers corresponding image data to the education module 171 through a suitable camera-device interface.

The education module 171, by controlling, comprising, or being operable with the audio output program 172 and the three-dimensional figure generation program 170, then augments the one or more video images—or the image data corresponding thereto—for presentation on the display 132 in response to interaction events initiated by the user. For example, in one embodiment, a user actuation target corresponds to the presentation of a three-dimensional, interactive rendering on the display 132 of the device 100. Accordingly, the education module 171 can be configured to superimpose a two-dimensional representation of an educational three-dimensional interaction object 181 on an image of the interactive book 150. The augmented image data is then presented on the display 132. To the user, this appears as if a three-dimensional rendering has suddenly “appeared” and is sitting atop the image of the interactive book 150. The user can then interact with the three-dimensional rendering by touching user actuation targets on the pages of the interactive book 150.

Illustrating by way of one simple example, in one embodiment the special marker 152 is a “play icon,” such as a rightward facing triangle in a circle as will be shown in subsequent figures. The education module 171 captures one or more images, e.g., a static image or video, of the interactive book 150 having the play icon disposed thereon. When the user covers the play icon with a hand or other object, the education module 171 detects this. The education module 171 then augments the one or more video images by causing the three-dimensional figure generation program 170 to superimpose a two-dimensional representation of an educational three-dimensional interactive rendering 181 on an image of the interactive book 150. The educational three-dimensional interactive rendering 181 is presented on the display 132 atop an image of the interactive book 150.

Using one simple example as an illustration, a particular page of the interactive book 150 may be describing a character called “Amos Alligator” as he gets ready for a trip. When the user places his hand over the play icon, a three-dimensional interactive rendering 181 of Amos standing at his home in a swamp may be presented. In one embodiment, the three-dimensional interactive rendering 181 is a high-definition three-dimensional environment corresponding to an illustration on the open pages of the interactive book 150.

The education module 171 may then have elements of the three-dimensional interactive rendering 181 prompt a user for inputs. For example, the education module 171 may have Amos as, “Please tell me what I need to do before I leave?” Or, alternatively the education module 171 may have Amos say, “I need to cut my grass and feed my frogs before I leave. How do I do that?”

The user may then touch other user actuation targets on the page to control Amos's actions. For example, the user may touch an illustration of switch grass on the open page of the interactive book 150. When this occurs, the education module 171 detects this gesture and causes Amos to slash his tail across the selected grass, thereby cutting it. Similarly, the user may touch one of Amos's frogs that are present as an illustration of the interactive book 150. Accordingly, the education module 171 may cause Amos to open a jar of flies and feed the selected frog. In one embodiment, once the various tasks are complete, the three-dimensional interactive rendering 181 may automatically be removed. In another embodiment, a user may cause the three-dimensional interactive rendering 181 to disappear by covering a predetermined user actuation target.

In one embodiment, an interactive element present in the three-dimensional interactive rendering 181 can be an animal. The animal can be a giraffe, gnu, gazelle, goat, gopher, groundhog, guppy, gorilla, or other animal. By superimposing a two-dimensional representation of a three-dimensional rendering of the animal on the three-dimensional interactive rendering 181, it appears—at least on the display 132—as if a three-dimensional animal is sitting or standing atop the three-dimensional interactive rendering 181. The system of FIG. 1 and corresponding computer-implemented method of teaching provides a fun, interactive learning system by which students can learn the alphabet, how to read, foreign languages, and so forth. The system and method can also be configured as an educational game.

The interactive book 150 can be configured as a series of book, each focusing on a different letter of the alphabet. Where letters and animals are used as the main character, the letter and the animal can correspond by the animal's name beginning with the letter. For example, the letter “A” can correspond to an alligator, while the letter “B” corresponds to a bear. The letter “C” can correspond to a cow, while the letter “D” corresponds to a dolphin. The letter “E” can correspond to an elephant, while the letter “F” corresponds to a frog. The letter “G” can correspond to a giraffe, while the letter “H” can correspond to a horse. The letter “I” can correspond to an iguana, while the letter “J” corresponds to a jaguar. The letter “K” can correspond to a kangaroo, while the letter “L” corresponds to a lion. The letter “M” can correspond to a moose, while the letter “N” corresponds to a needlefish. The letter “O” can correspond to an orangutan, while the letter “P” can correspond to a peacock. The letter “R” can correspond to a rooster, while the letter “S” can correspond to a shark. The letter “T” can correspond to a toucan, while the letter “U” can correspond to an upland gorilla or a unau (sloth). The letter “V” can correspond to a vulture, while the letter “W” can correspond to a wolf. The letter “Y” can correspond to a yak, while the letter “Z” can correspond to a zebra. These examples are illustrative only. Others correspondence criterion will be readily apparent to those of ordinary skill in the art having the benefit of this disclosure.

In one embodiment, the education module 171 can cause audible sounds to emit from the device 100 by way of the audio output program 172. For example, when text appears on a particular page of the interactive book 150, covering a “read the text” user actuation target can cause the education module 171 to generate a signal representative of an audible pronunciation of a text stating. Using the Amos the Alligator example from above, the audible pronunciation may state, “Amos Alligator has a flight. It will leave tomorrow night. He has a plan, and is map is ready too, but look what Amos has to do! Feed the frogs, and trim the weeds, help Amos do the things he needs.” This pronunciation can be configured to be suitable for emission from a loudspeaker. Alternatively, phonetic sounds or pronunciations of the name of the building can be generated.

In another audio example, presume that the visible object 151 is the Amos sleeping. In one embodiment, the text may read, “The swamp welcomes the morning bright, but Amos does not like the light. The rooster crows, the birds all sing, but Amos does not hear a thing. Wake up Amos! Time to go, or you will miss your flight, you know!” A voice over may read this text via the audio output program 172 through the loudspeaker. Alternatively, an indigenous sound made by the animal, such as an alligator's roar. This sound may be played in addition to, or instead of, the voice over. Further, ambient sounds for the animal's indigenous environment, such as jungle sounds in this illustrative example, may be played as well.

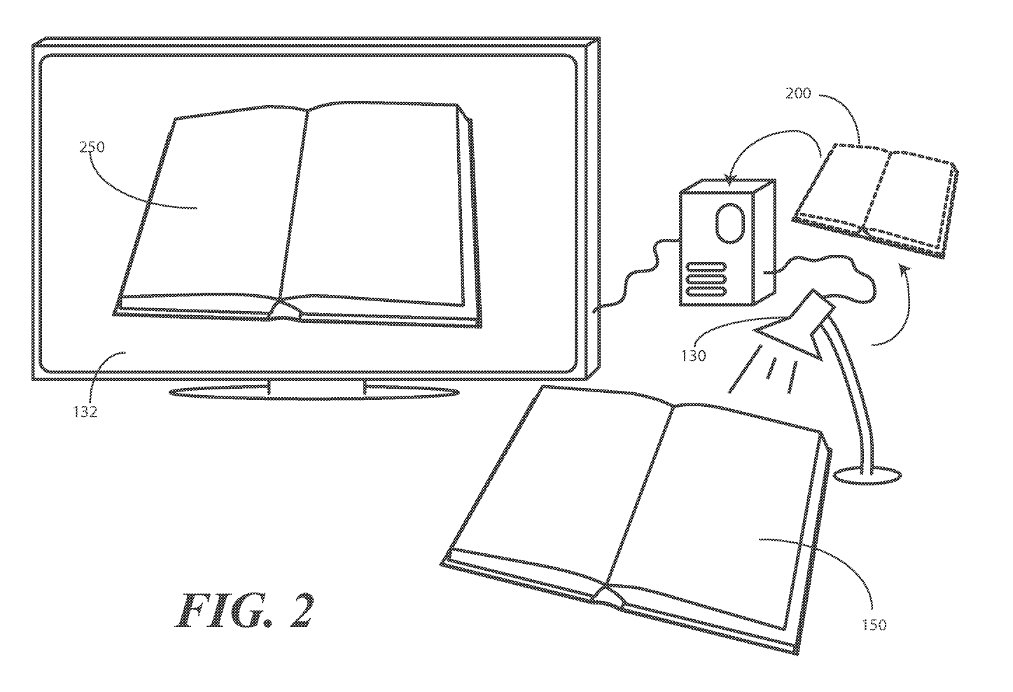

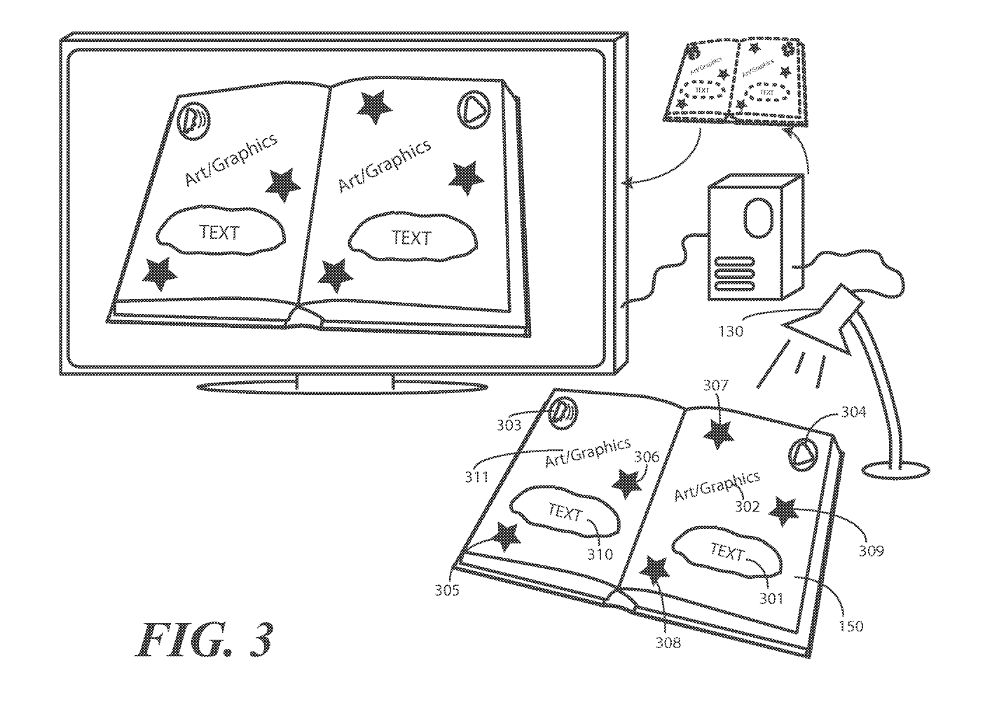

Turning now to FIGS. 2 and 3, illustrated therein are the initial steps of one exemplary computer-implemented method of teaching reading in accordance with one or more embodiments of the invention. For simplicity of discussion, the system is configured as an augmented reality system for teaching reading and associated instructional concepts, and the computer-implemented method is configured as a computer-implemented method of teaching reading and instructional concepts. However, it will be clear to those of ordinary skill in the art having the benefit of this disclosure that embodiments of the invention could be adapted to teach things other than reading or instructional concepts. For example, the use cases described below could be adapted to teach arithmetic, mathematics, or foreign languages. Additionally, the use cases described below could also be adapted to teach substantive subjects such as anatomy, architecture, chemistry, biology, or other subjects.

Beginning with FIG. 2, the camera 130 captures an image, represented electronically by image data 200. As shown in FIG. 2, the image data 200 corresponds to an image of an interactive book 150. The image data 200 can be from one of a series of images, such as where the camera 130 is capturing video. The image data 200 is then delivered to the device 100 having the education module (171) operable therein. An image 250 of the interactive book 150 can then be presented on the display 132.

As shown in FIG. 3, the open pages 300 of the book can include text 301,310, art and/or graphics 302,311, and one or more user actuation targets 303,304,305,306,307,308,309. Each of these elements can include a special marker (152) so that the education module (171) can correlate a predefined function with each element. The user actuation targets 303,304,305,306,307,308,309 are configured as printed icons that are recognizable by the camera 130 and identifiable by the education module (171). When the user actuation targets 303,304,305,306,307,308,309 are visible to the camera 130, the education module (171) is configured not to react to any of these targets. However, when one or more of the user actuation targets 303,304,305,306,307,308,309 becomes hidden, such as when a user's finger is placed atop one of the targets and covers that target, the education module (171) is configured in one embodiment to actuate a multimedia response. The multimedia response can take a number for forms, as the subsequent discussion will illustrate.

In the illustrative embodiment of FIG. 3, user actuation target 303 comprises a “read text” element. User actuation target 304 comprises a “play” element. User actuation targets 305,306,307,308,309 can be interaction targets. The uses of each of these will be described in detail in following figures.

In one embodiment, when the user covers user actuation target 303, the education module (171) reads the text 301,310 on the open pages 300 of the interactive book 150. In one embodiment, when the user covers user actuation target 304, the education module (171) augments the one or more video images for presentation on a display by causing the three-dimensional figure generation software (170) to superimpose a two-dimensional representation of interactive rendering of the art and/or graphics 302,311 present on the open pages 300 of the interactive book 150. Note that in the discussion below, the education module (171) will be described as doing the superimposing. However, it will be understood that this occurs in conjunction with the three-dimensional figure generation software (170) and/or audio output program (172) as described above.

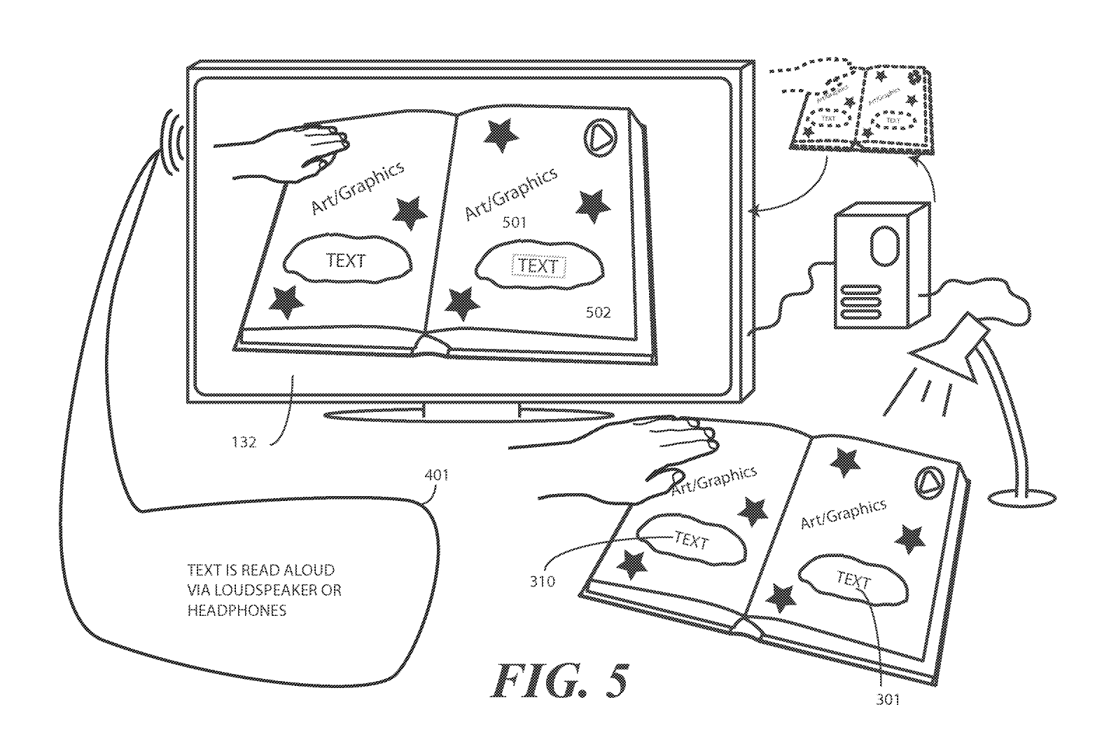

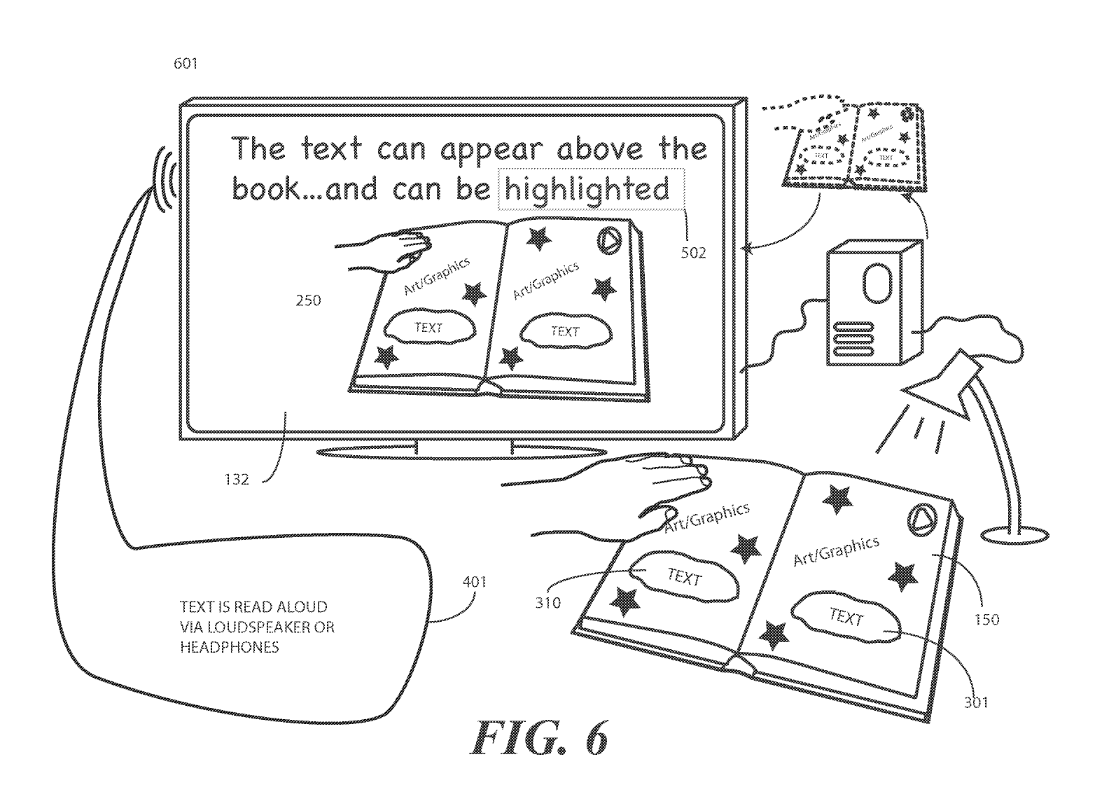

Turning now to FIG. 4, the user 400 has covered the read text element. Accordingly, the education module (171) causes the audio output program (172) to read 401 the text 301,310 out loud via a loudspeaker of the electronic device 100. As shown in FIG. 4, audible sounds 402 are emitted from a loudspeaker. As shown in FIG. 5, in one embodiment, while the image 501 of the text 301 can optionally be highlighted 502 on the display 132 while the text is being read 401. As shown in FIG. 6, the text 301,310 can be presented in a text presentation region 601 disposed above an image 250 of the interactive book 150 on the display 132. Covering user actuation target (303) allows a student to hear the text 301,310 while it is being read 401. This reinforces the student's knowledge of the pronunciation and meaning of the text 301,310. When highlighting 502 is used, the student understands which pronunciation corresponds with which word of the text 301,310.

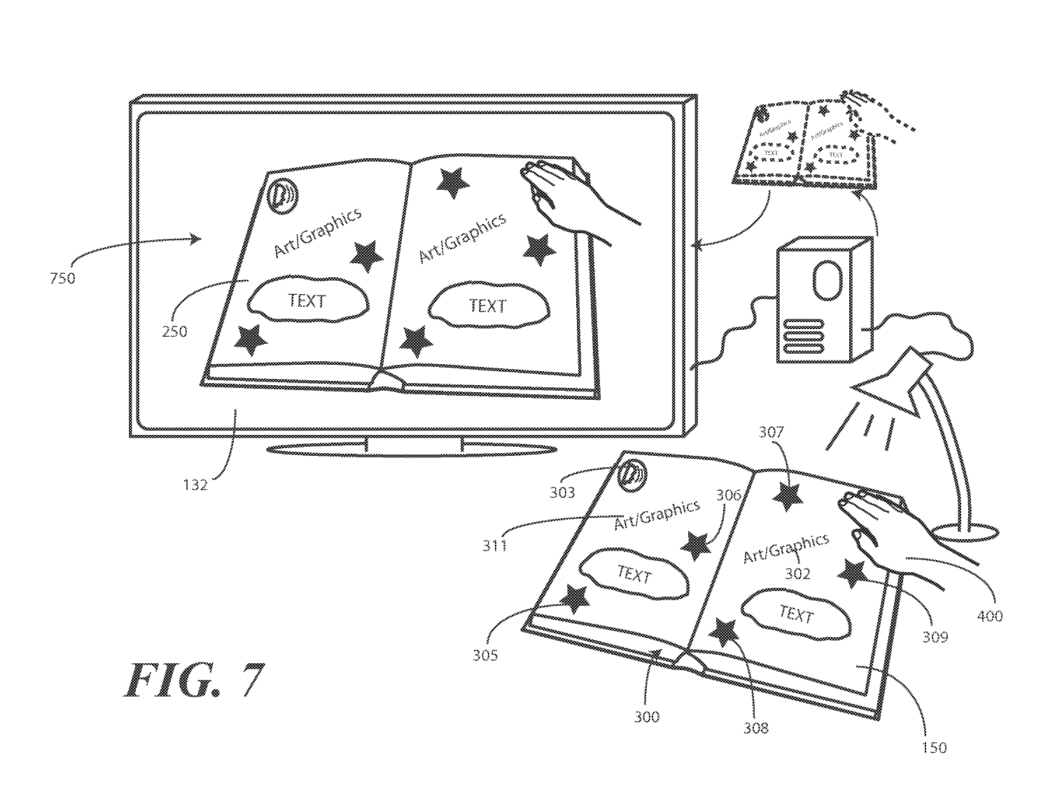

Turning now to FIG. 7, illustrated therein is the user 400 covering the play element of the open pages 300 of the interactive book 150. In one embodiment, the functionality of the play element may be precluded until user actuation target 303 has been covered to read the text (301,310) as described above with reference to FIGS. 4-6. Said differently, in one embodiment, the education module (171) can be configured to prevent the user 400 from proceeding to an interactive game or other interactive feature by not effecting the function associated with the play element until the user has first covered user actuation target 303. Accordingly, a student must experience the reading lesson before proceeding to the game or interactive portion. In other embodiments, no restrictions are placed on the order in which user actuation 303 and user actuation target (304) can be engaged. In yet another embodiment, the preclusion is user definable such that a parent can, in some instances, require the reading lesson to occur before the interaction portion, while in other instances allowing them to occur in any order.

When the user covers the play element, i.e., user actuation target (304), the education module (171) transforms the displayed image 750 into an interactive session or game. This can be done, in one embodiment, by superimposing a two-dimensional representation of a three-dimensional rendering of the art and/or graphics 302,311 to appear on the display 132 as if “floating” above the image 250 of the interactive book 150. The user can then interact with the interactive session or game by covering the other user actuation targets 305,306,307,308,309.

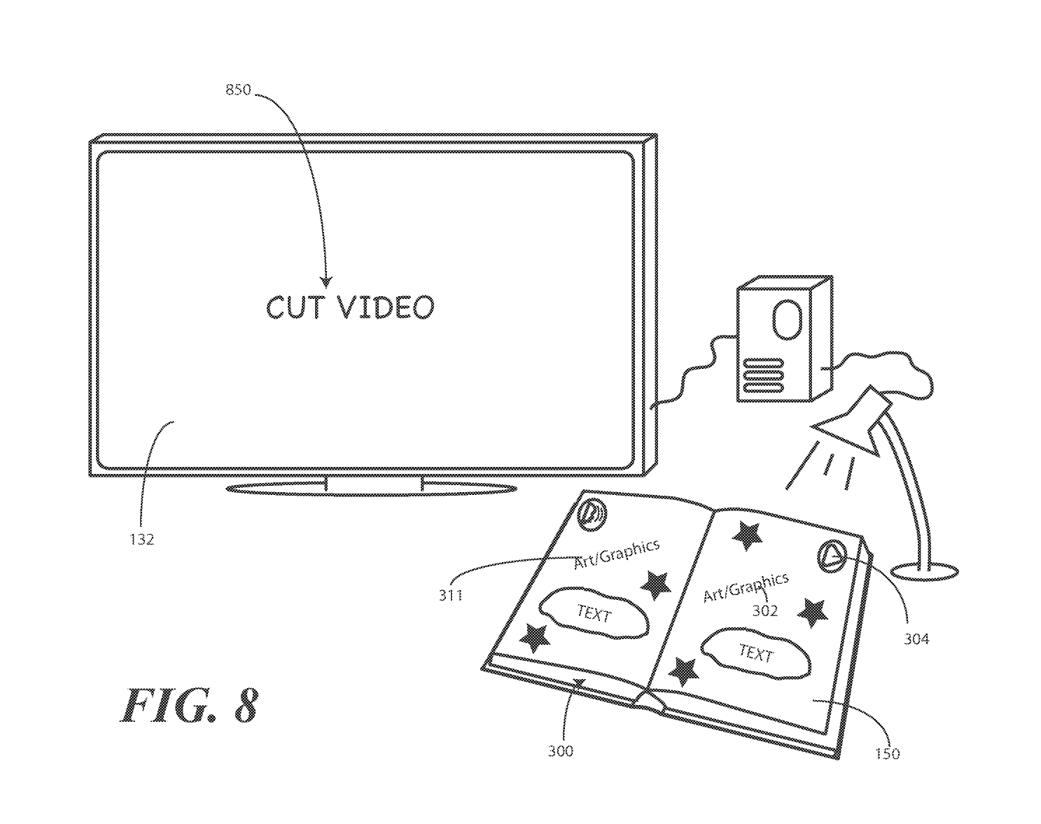

In one embodiment, the interactive session or game appears instantaneously when the user 400 covers the play element. However, to further aid in the teaching process, in one or more embodiments a “cut video” is played after the user 400 covers the play element and before the interactive session or game. As shown in FIG. 8, in one embodiment a cut video 850 is presented on the display after the user (400) has covered user actuation element 304.

A cut video 850, in one embodiment, is a clip or short that sets up the interactive session or game that will follow. The cut video 850 can provide a transitional story between the art and/or graphics 302,311 present on the open pages 300 of the interactive book 150 and the upcoming interactive session or game. In another embodiment, the cut video 850 may simply be an entertaining video presented between the covering of user actuation target 304 and the upcoming interactive session or game. For example, where the interactive session is a game where Amos Alligator has to navigate logs along a river in the swamp, the cut video 850 may be a snippet of Amos riding in an airboat. The cut video 850 may show the details of the boat, may show Amos talking about the features of the swamp, and so forth. In one or more embodiments, the cut video 850 comprises an entertainment respite for the student that fosters encouragement for the student to continue with the book. The more lessons through which the student passes, the more cut videos they will be able to see. In one embodiment, the various cut videos 850 associated with each play element form a supplemental story that is related to, but different from, the story of the interactive book 150. Accordingly, making it through each of the lessons in the open pages 300 allows the student to “decode the mystery” of learning what story is told by the cut video 850 clips. In one embodiment, the cut video 850 is presented as a full-screen image on the display 132. In another embodiment, the cut video 850 can be presented as an element that appears to float over the image (250) of the interactive book 150 present on the display 132.

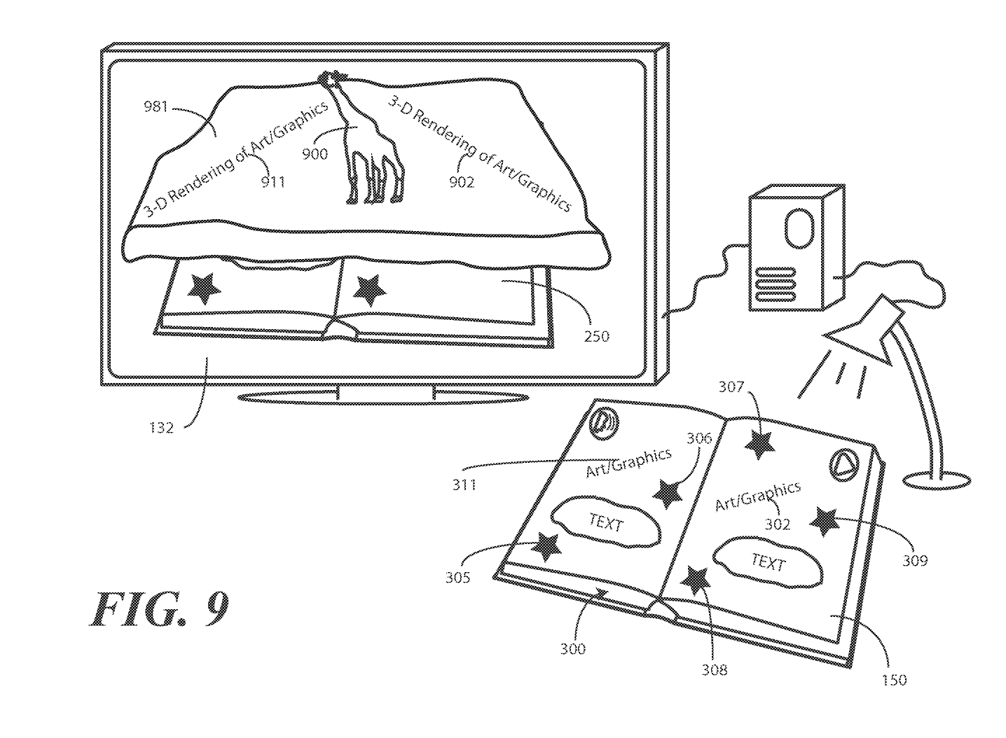

Once the cut video 850 has completed, or in another embodiment immediately after the user (400) has covered user actuation target (304), the education module (171) can superimpose the three-dimensional interactive rendering (181) on the image (250) of the interactive book 150. Turning to FIG. 9, illustrated therein is one three-dimensional interactive rendering 981 being superimposed atop the image 250 of the interactive book 150 on the display 132. In this illustrative embodiment, the three-dimensional interactive rendering 981 is a section of an African plain upon which a three-dimensional character 900, shown here as a giraffe, lives. The three-dimensional interactive rendering 981 can include additional elements as well, such as trees, other animals, other objects, and so forth. In one embodiment, the three-dimensional interactive rendering 981 comprises a three-dimensional rendering of art and/or graphics 902,911 corresponding to the art and/or graphics 302,311 present on the open pages 300 of the interactive book 150.

In one embodiment, the three-dimensional interactive rendering 981 can be modeled by the education module (171) as a three-dimensional model that is created by the three-dimensional figure generation program (170). In another embodiment, the three-dimensional interactive rendering 981 can be stored in memory as a pre-defined three-dimensional model that is retrieved by the three-dimensional figure generation program (170). The education module (171) can be configured so that the elements present in the three-dimensional interactive rendering 981, e.g., animals, plants, etc., are textured and has an accurate animation of how the each element moves. In one embodiment, the customized education module can be configured to play sound effects. The sounds can be repeated in one embodiment via the keyboard and the background sounds can be toggled on or off.

Illustrating with another example, the three-dimensional interactive rendering 981 may be Amos Alligator standing at his home in a swamp preparing to get ready for a trip. The other objects present with Amos in the three-dimensional interactive rendering 981 may include a suitcase, keys, socks, shoes, plane tickets, a hat, and so forth. The three-dimensional interactive rendering 981 may thus comprise an interactive session in which the student can help Amos pack for his trip.

In one embodiment, the student does this by selectively covering user actuation targets 305,306,307,308,309 disposed along the open pages 300 of the interactive book. The education module (171) may cause Amos to say, “Will you help me pack? What do you think I need?” User actuation target 305 may correspond to Amos's plane tickets. When the student covers user actuation target 305, this may cause the tickets present in the three-dimensional interactive rendering 981 to “jump” into Amos's suitcase. Similarly, if user actuation target 308 corresponds to Amos's shoes, covering this user actuation target 308 can cause the shoes to jump into the suitcase as well.

In one embodiment, when each of the items Amos needs for the trip have been found and placed into the suitcase, the three-dimensional interactive rendering 981 is removed thereby allowing the student to transition to the next page. In another embodiment, when each of the items Amos needs for the trip have been found and placed into the suitcase, an exit icon appears in the three-dimensional interactive rendering 981. By covering a user actuation target corresponding to the exit icon, e.g., user actuation target 309, the three-dimensional interactive rendering 981 is removed. In yet another embodiment, the user is able to remove the three-dimensional interactive rendering 981 at the time of their choosing by covering a predefined user actuation target.

In one embodiment, the education module (171) can be configured to detect movement of the interactive book 150. For example, if a student picks up the interactive book 150 and moves it side to side beneath the camera 130, the education module (171) can be configured to detect this motion from the image data (200) and can cause the presentation on the display 132 to move in a corresponding manner. Similarly, the education module (171) can be configured to cause the presentation on the display 132 to rotate when the student rotates the interactive book 150. Likewise, the education module (171) can be configured to tilt the presentation on the display 132 when the interactive book 150 is tilted, in a corresponding amount. This motion works to expand the interactive learning environment provided by embodiments of the present invention.

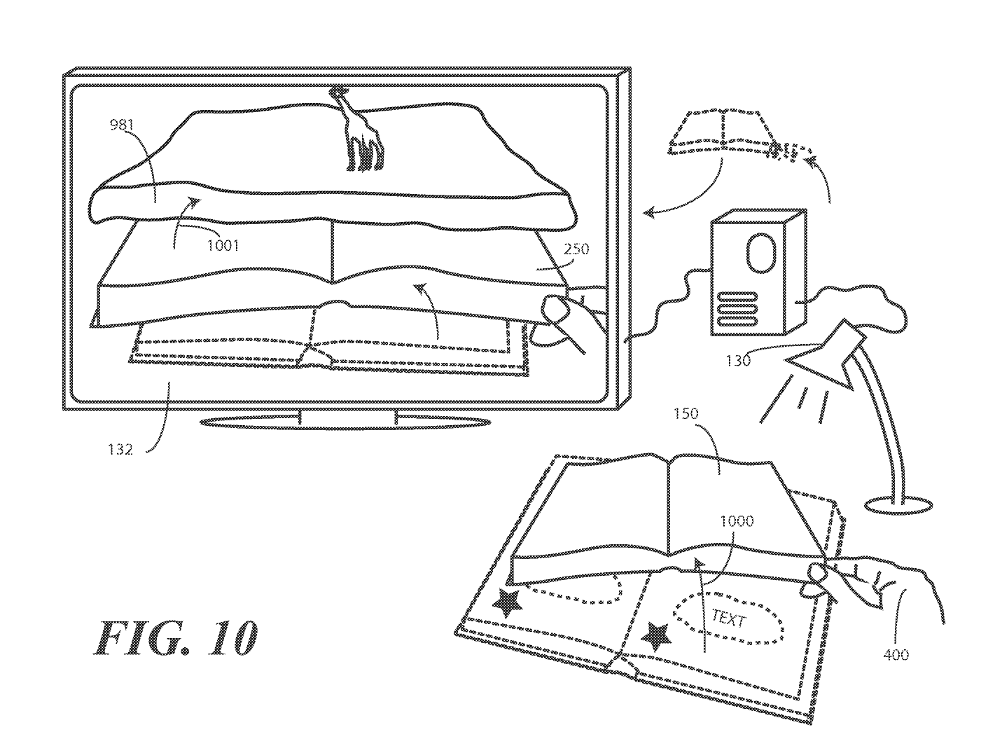

One embodiment of this motion alteration is shown in FIG. 10. As shown in FIG. 10, in one embodiment, the three-dimensional interactive rendering 918 is presented on the display 132 in an alignment that is presented at a fixed relationship relative to the image 250 of the interactive book 150. Accordingly, when the user 400 tilts 1000 the interactive book 150, the three-dimensional interactive rendering 918 tilts 1001 as well on the display 132. This provides the user 400 with a mechanism for examining the three-dimensional interactive rendering 981 in more detail. Moving the interactive book 150 closer to the camera 130 causes a “zoom in” action of the three-dimensional interactive rendering 918 on the display 132 in one embodiment, while moving the interactive book 150 farther from the camera 130 causes a “zoom out” action. In one embodiment, rotating the interactive book 150 allows different sides of the three-dimensional interactive region to be seen.

In the illustrative embodiment of FIG. 10, tilting 1000 the interactive book 150 allows the surface underneath the three-dimensional interactive rendering 918 to be seen. For example, in FIG. 10 the three-dimensional interactive rendering 918 is a section of an African plain. Accordingly, one might tilt 1000 the interactive book 150 to see what is “below” the surface of a section of an African plain. When the three-dimensional interactive rendering 918 is tilted 1001, the underside may reveal fossils, roots, aquifers, oil deposits, or in a fictional embodiment, a wizard and a bunch of crazy gears responsible for running the earth.

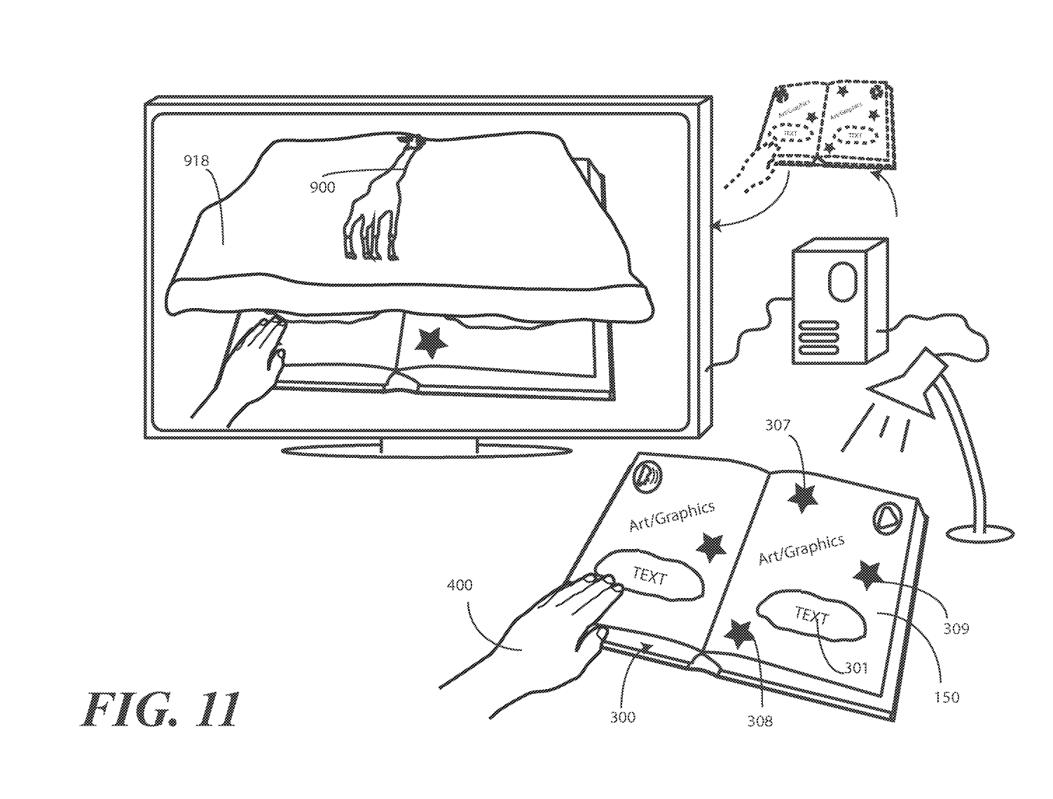

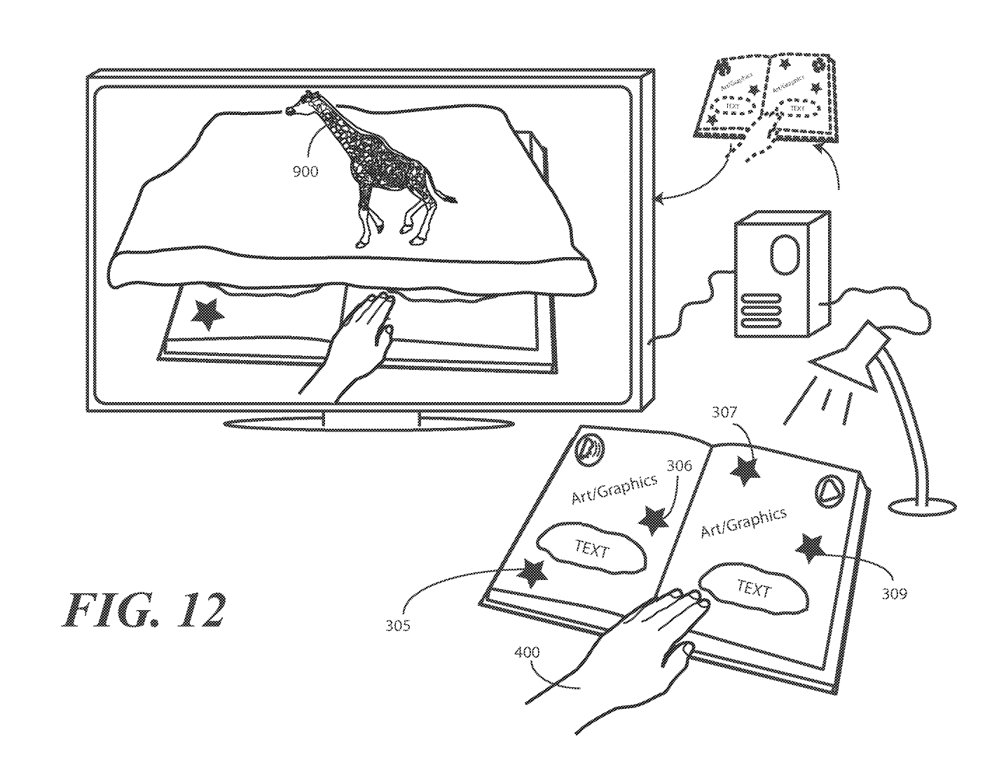

Turning now to FIGS. 11 and 12, the user 400 is shown interacting with the three-dimensional interactive rendering 918 by covering various user actuation targets 305,308. In FIG. 11, the user 400 is covering user actuation target 305, while in FIG. 12 the user 400 is covering user actuation target 308.

In one embodiment, covering these user actuation targets 305,308 causes the education module (171) to animate a character 900 in the three-dimensional interactive rendering 918 present on the display 132. As shown in FIG. 11, covering user actuation target 305 has caused the giraffe to turn around. As shown in FIG. 12, covering user actuation target 308 has caused the giraffe to run.

In one or more embodiments an interactive session can be arranged where the education module (171) prompts the user to find and cover one of the user actuation targets 305,306,307,308,309. Continuing with the Amos Alligator example, imagine the three-dimensional interactive rendering 918 being a three-dimensional image of Amos as the character 900 standing near his home in the swamp. The text 301 on the open pages 300 of the interactive book 150 may say, “Amos has a plan, and his map is ready too, but look what Amos has to do! Feed the frogs and trim the weeds, help Amos do the things he needs.” Accordingly, when the three-dimensional interactive rendering 918 appears, the education module (171) can cause Amos to say, “Help me trim my weeds and feed my frogs, will you?” Where user actuation target 306 is a picture of weeds, covering this user actuation target 306 may cause Amos to swash his tail and cut a three-dimensional rendering of the weeds present in the three-dimensional interactive rendering 981. While doing so, Amos may say, “Those weeds are really tall, they do need cutting!” Similarly, where user actuation target 307 is an image of a frog, covering this user actuation target 306 may cause Amos to open a jar of flies and feed a corresponding three-dimensional rendering of a frog in the three-dimensional interactive rendering 981 while saying, “Yep, that one looks awful hungry.” This example is explanatory only, as any number of other examples will be obvious to those of ordinary skill in the art having the benefit of this disclosure.

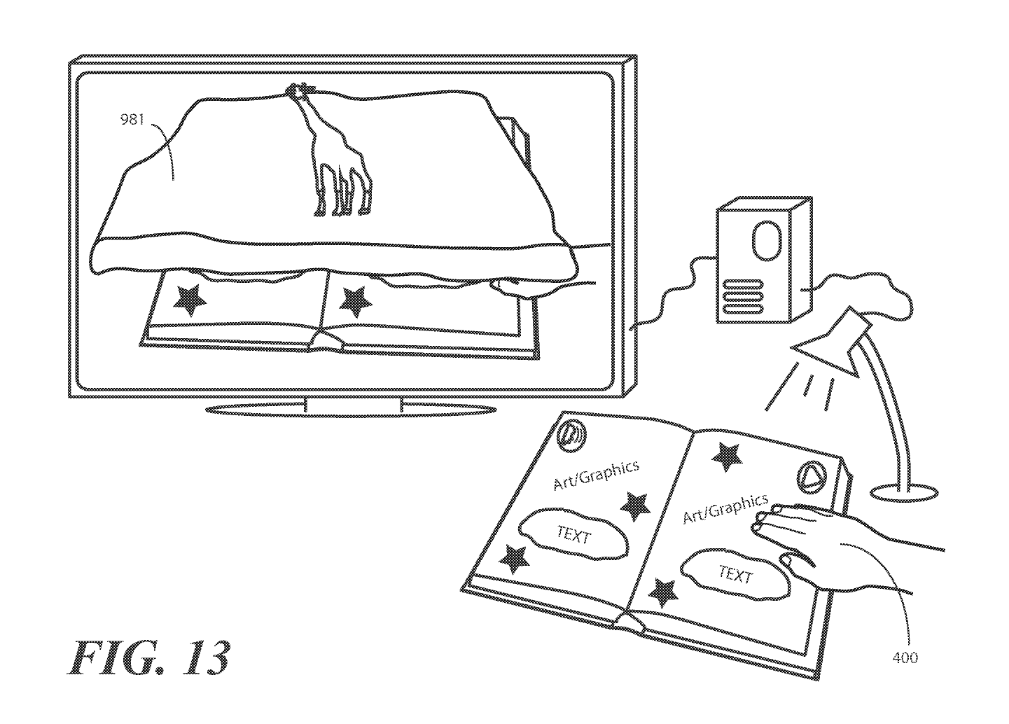

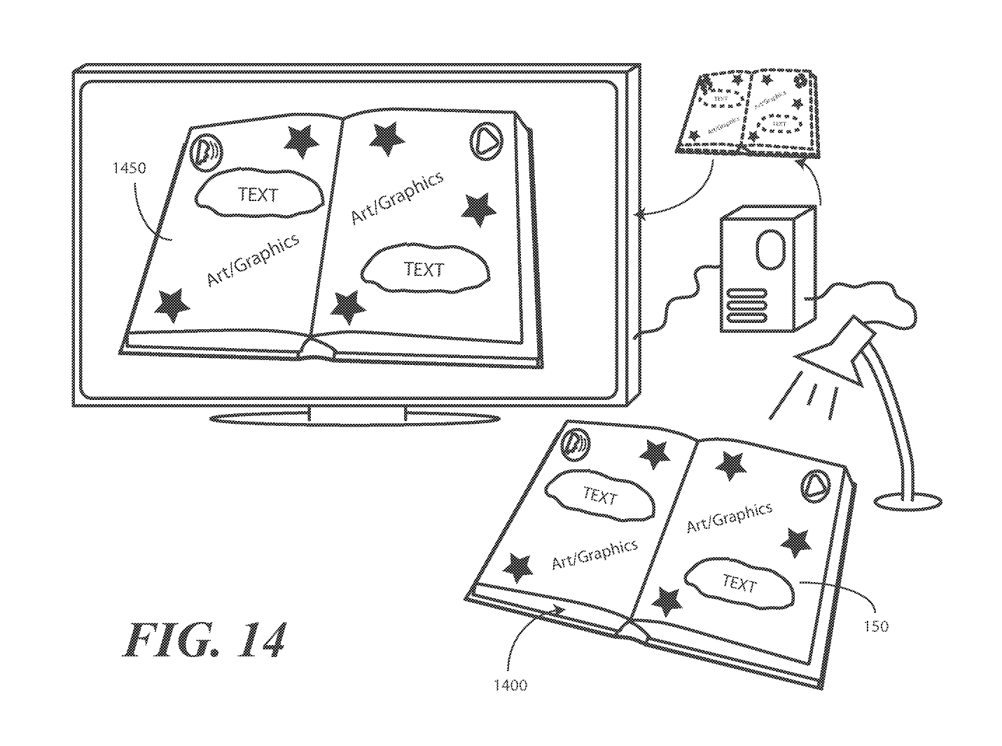

Turning now to FIG. 13, in one embodiment the user 400 can cause the three-dimensional interactive rendering 981 to disappear by covering another user actuation target, which in this illustrative embodiment is user actuation target (309). As noted above, in one embodiment this user actuation target (309) may be enabled only once all necessary tasks of the interaction session are completed. Using the example from the preceding paragraph, user actuation target 309 may be enabled only once Amos has cut all of his weeds and fed all of his frogs. In another embodiment, user actuation target (309) can be enabled all the time, thus allowing the user 400 to exit the interactive session at the time of the their choosing. As shown in FIG. 14, once the three-dimensional interactive rendering (981) is removed, the interactive book 150 can be turned to a new opened page 1400. The new image 1450 of the new opened page 1400 is then presented on the display 132 and the process can repeat until the interactive book 150 is finished.

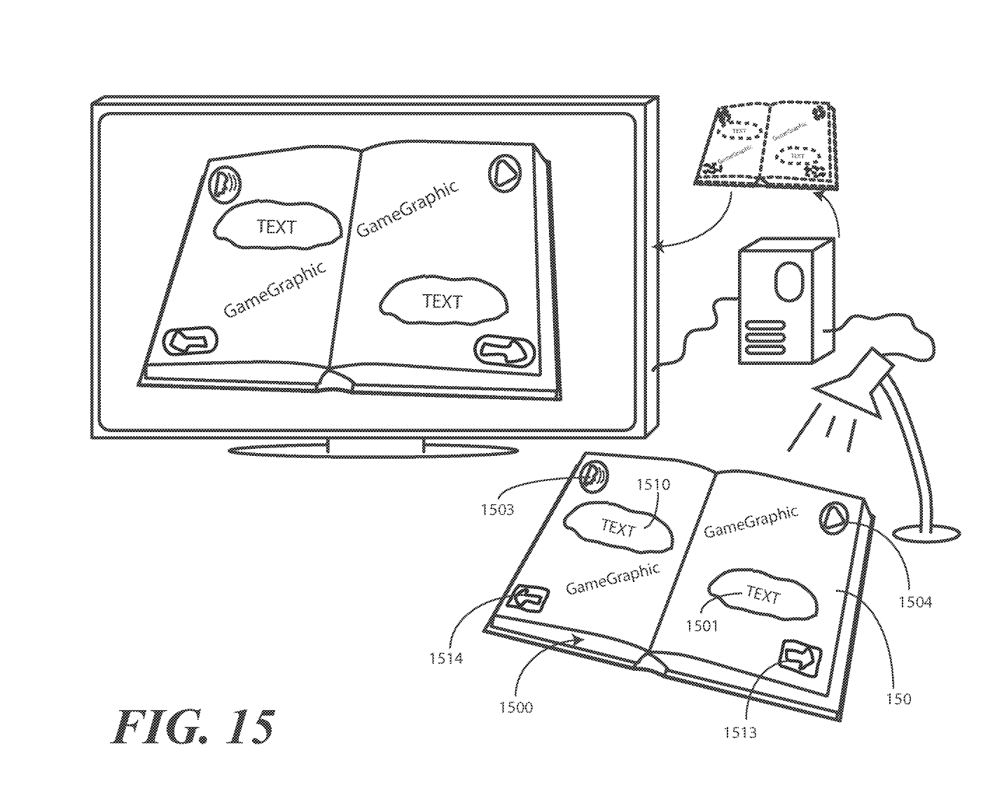

FIGS. 11-13 describe and illustrate an interactive session that can be provided with methods and systems configured in accordance with embodiments of the present invention. However, it will be clear to those of ordinary skill in the art having the benefit of this disclosure that other types of interactive events can be provided as well. Turning now to FIG. 15, illustrated therein is an explanatory alternative interactive event.

The open pages 1500 of the interactive book 150 shown in FIG. 15 correspond to an interactive game. This can be seen by the inclusion of game control user actuation targets 1513,1514. In this illustrative embodiment, game control user actuation target 1513 is a “move right” control, while game control user actuation target 1514 is a “move left” control. While two game controls are shown, it will be clear to those of ordinary skill in the art having the benefit of this disclosure that other numbers and types of game controls could be equally provided. Examples of additional game controls include jump controls, move up controls, move down controls, and so forth.

As with previous open pages (300,1400), the open pages 1500 of FIG. 15 include a read text element 1503 and a play element 1504. Other user actuation targets can be included as well. As with previous figures, the user can cover the read text element 1503 to cause the text 1501,1510 to be read by the education module (171).

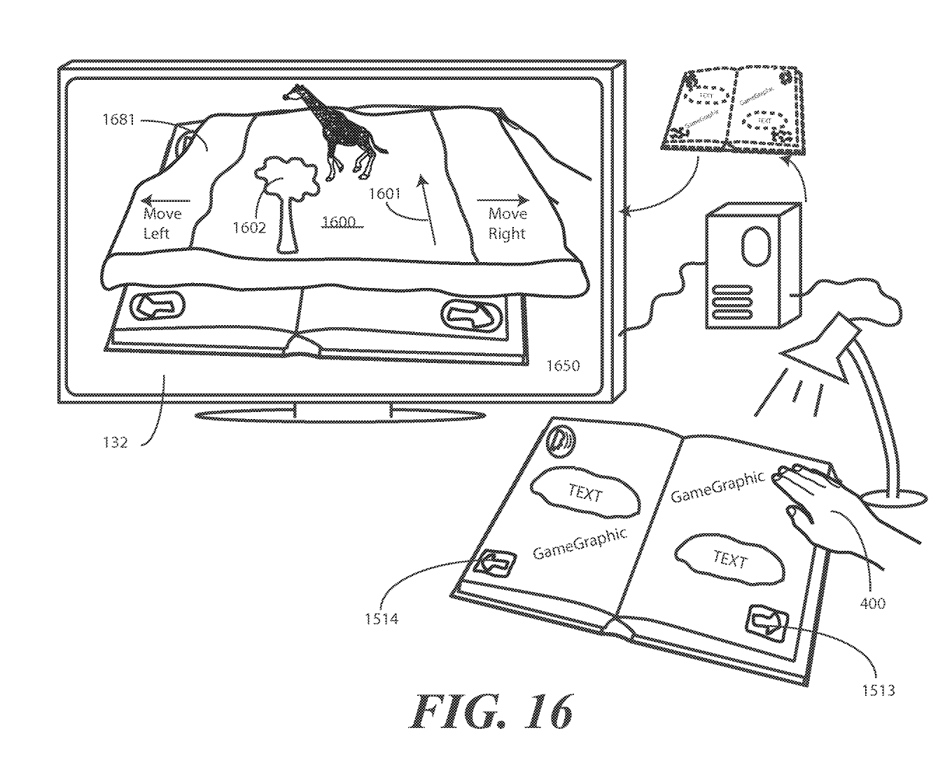

When the user covers the play element 1504, as shown in FIG. 16, the education module (171) presents a three-dimensional game rendering 1581 on the display 132. As with previous renderings, the three-dimensional game rendering 1581 is shown in FIG. 16 as appearing to hover over the image 1650 of the interactive book 150.

The three-dimensional game rendering 1581 differs from the interactive sessions above in that an educational game is presented. The game control user actuation targets 1513,1514 can be used to control a character 900 in a game. In the illustrative embodiment of FIG. 16, the educational game is teaching the directional concepts of right and left. The character 900 is shown standing in a path 1600 that is moving 1601 towards the character. Obstacles 1602 are present at various points in the path. To successfully navigate the educational game, the user 400 must selectively cover the game control user actuation targets 1513,1514 to move the character right and left to avoid the obstacles.

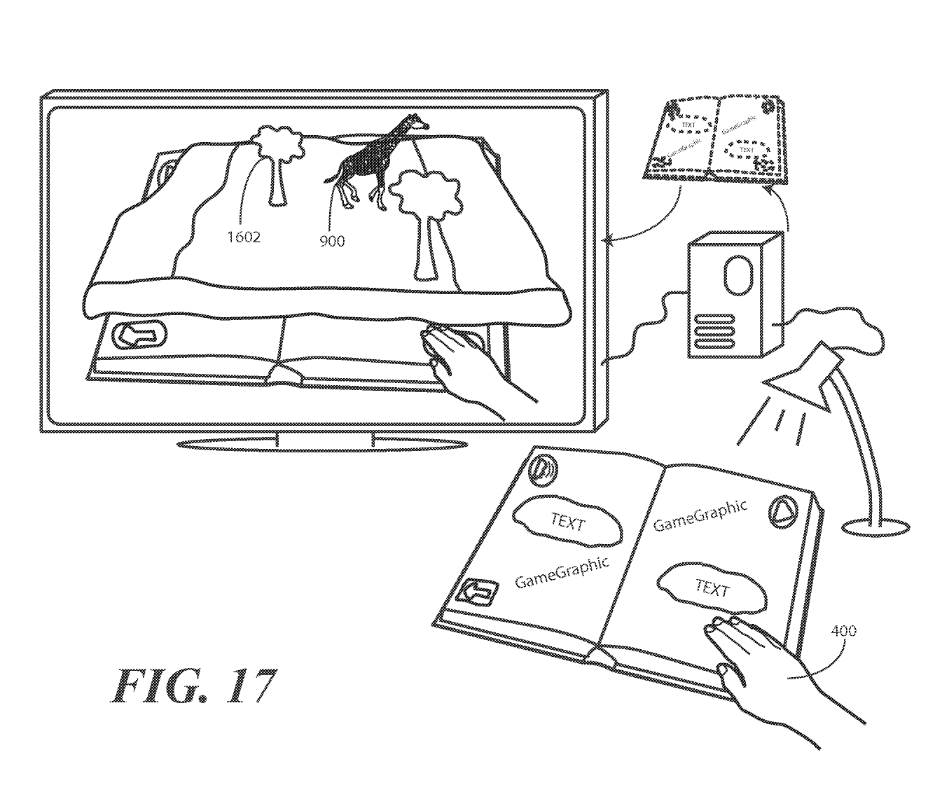

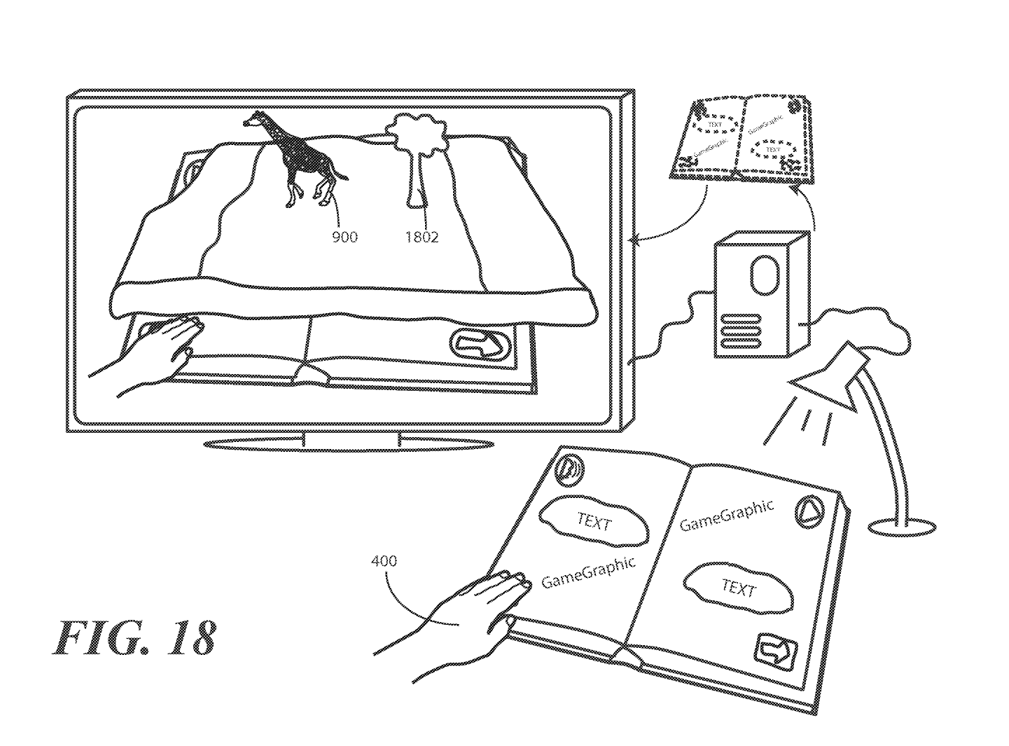

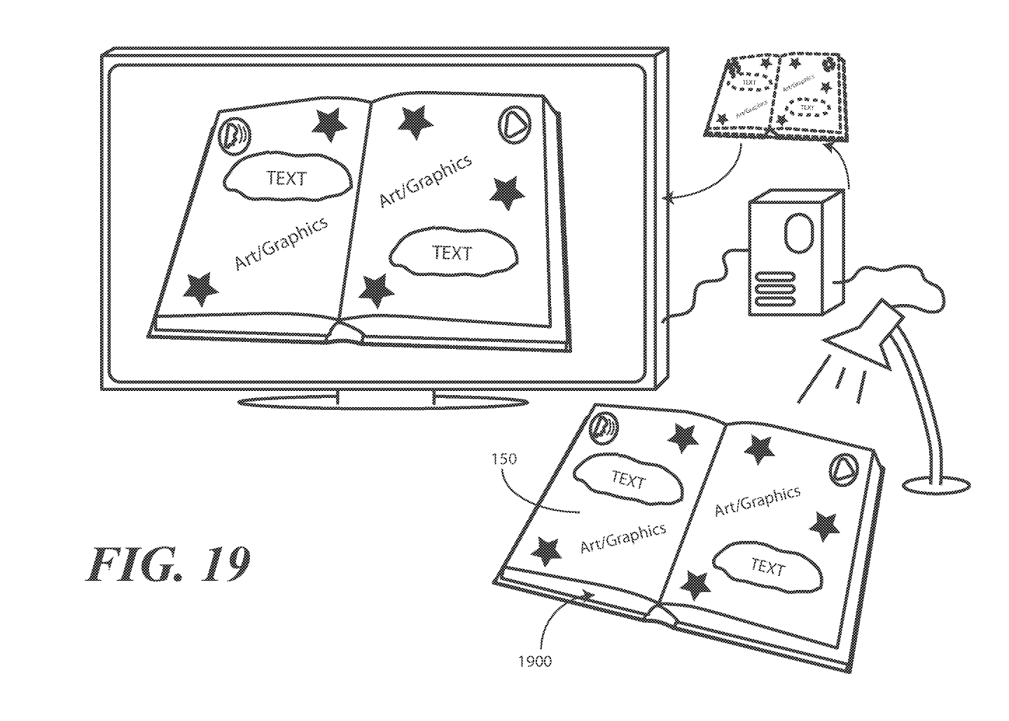

Illustrating by example, turning to FIG. 17, the user 400 has covered the move right game control user actuation target to cause the character 900 to move to the right, thereby avoiding the first obstacle 1602 as it moves from the foreground to the background. As shown in FIG. 18, the user 400 has covered the move left game control user actuation target to cause the character 900 to move to the left, thereby dodging the second obstacle 1802. Once the game is complete, the three-dimensional game rendering (1581) can be removed. In one embodiment, this occurs automatically. In another embodiment, the user may cover another user actuation target to cause the three-dimensional game rendering (1581) to be removed. Once this occurs, the user 400 is able to turn to another open page 1900 of the interactive book 150 as shown in FIG. 19.

There are many different ways the education module (171) can be varied without departing from the spirit and scope of embodiments of the invention. By way of example, in one embodiment a user can introduce his own objects into the camera's view and have the three-dimensional object react and interact with the new object. In another embodiment, a user can purchase an add-on card like a pond or food and have the animals or other elements present in a three-dimensional interactive rendering interact with the new elements. In another embodiment, a marker can be printed on a t-shirt and when the user steps in front of the camera, they are transformed into the three-dimensional interactive renderings. These examples are illustrative only and are not intended to be limiting. Others will be obvious to those of ordinary skill in the art having the benefit of this disclosure.

In the foregoing specification, specific embodiments of the present invention have been described. However, one of ordinary skill in the art appreciates that various modifications and changes can be made without departing from the scope of the present invention as set forth in the claims below. Thus, while preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims.

What is claimed is:

1. A computer-implemented method of teaching, comprising:
capturing one or more video images of an interactive book; and
augmenting the one or more video images for presentation on a display of an electronic device with an education module by superimposing a three-dimensional rendering on an image of the interactive book.

2. The method of claim 1, wherein pages of the interactive book have one or more user actuation targets disposed thereon.

3. The method of claim 2, wherein:
the pages further comprise text disposed thereon;
the one or more user actuation targets comprise a read text element; and
when the read text element is covered, causing with the education module the text to be read aloud.

4. The method of claim 2, wherein:
the one or more user actuation targets comprise a play element; and
the three-dimensional rendering is presented only after the play element is covered.

5. The method of claim 4, further comprising presenting a cut video after the play element is covered and before the augmenting.

6. The method of claim 1, wherein:
pages of the interactive book has one or more of art or graphics disposed thereon; and
the three-dimensional rendering comprises a three-dimensional rendering of elements included in the one or more of art or graphics.

7. The method of claim 2, wherein the three-dimensional rendering comprises a three-dimensional interactive rendering.

8. The method of claim 7, further comprising animating elements of the three-dimensional interactive rendering when at least one of the one or more user actuation targets is covered.

9. The method of claim 8, further comprising delivering a prompt requesting that the at least one of the one or more user actuation targets be covered.

10. The method of claim 7, wherein the three-dimensional interactive rendering comprises an interactive game.

11. The method of claim 10, wherein at least some of the one or more user actuation targets comprise game control user actuation targets.

12. A educational system, comprising:
an input configured to receive a image data; and
an education module, configured to:
detect indicia from an interactive book in the image data;
augment the image data by inserting a three-dimensional interactive rendering into the image data above an image of the interactive book to create augmented image data; and
present the augmented image data on a display.

13. The educational system of claim 12, wherein the interactive book comprises reading instructional materials.

14. The educational system of claim 12, wherein pages of the interactive book comprise user actuation targets, wherein the user actuation targets comprise a read text element and a play element.

15. The educational system of claim 14, wherein the education module is configured to read text from the pages of the interactive book when the read text element is covered.

16. The educational system of claim 14, wherein the education module is configured to present the augmented image data on the display only after the play element is covered.

17. The educational system of claim 16, wherein the education module is configured to present a cut video after the play element is covered and before the augmented image data is presented.

18. The educational system of claim 12, wherein the education module is configured to move the three-dimensional interactive rendering when movement of the interactive book is detected.

19. The educational system of claim 12, wherein the education module is configured to animate one or more elements of the three-dimensional interactive rendering when one or more user actuation targets present on pages of the interactive book are covered.

20. The educational system of claim 12, wherein pages of the interactive book comprise a three-dimensional rendering removal user actuation target, wherein the education module is configured to preclude usage of the three-dimensional rendering removal user actuation target until a predetermined criterion is met.
